(19) United States
(12) Patent Application Publication
(10) Pub. No.: US 2008/0172260 A1
(43) Pub. Date: Jul. 17, 2008

(54) EFFICIENT CASH ACCUMULATION WITHIN AN INSURANCE POLICY

(75) Inventors: Ryan S. Thacker, Highland, UT (US); Tyson P. Thacker, Highland, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Infinity Publishing, LLC, Lehi, UT (US)

(21) Appl. No.: 12/036,070

(22) Filed: Feb. 22, 2008

(51) Int. Cl. G06Q 40/00

(52) U.S. Cl. 705/4

(57) ABSTRACT

The use of an insurance policy to accumulate a cash balance. The insurance policy is set up, however, such that a cash balance can be accumulated rapidly. The insurance policy is structured such that a portion of a premium for the insurance policy is directed towards non-term coverage that results in some accumulation of cash balance in the insurance policy, and a portion of the premium for the insurance policy is directed towards term coverage. The insurance policy permits additional cash payments beyond the premium to be paid as a cash value increase to the insurance policy. Although these additional cash payments have a limit, the limit may be greater due to the presence of the term coverage than it would be without the term coverage.

### BACKGROUND

A bank is a financial institution that serves as a destination for capital in the form of deposits, and a source of capital in the form of withdrawals and loans. In order to be profitable, banks will often loan out a large portion of their deposits in order to be able to pay the interest on the deposits, pay the overhead associated with the bank, and make a profit. The banks typically keep a sufficient balance in reserve to satisfy withdrawals, which are given priority over loans.

There are insurance policies that allow cash balances to be accumulated. Often those cash balances may be withdrawn by the owner in the form of a loan that is paid back into the balance with interest. The use of an insurance policy to create a cash balance has some of the attributes of a bank, with some benefits as compared to a bank, and some detriments as compared to a bank.

One of the detriments has been that it takes some time to accumulate a cash balance in an insurance policy. In some case, it may take years of paying premiums before there is any cash balance at all in the insurance policy. As noted by author Nelson Nash in his book BECOME YOUR OWN BANKER™ that describes THE INFINITE BANKING CONCEPT™, this detriment at least with respect to whole life insurance can be mitigated through the use of “paid up additions” or “paid up insurance”. This mechanism allows additional money to be paid to the insurance company, where that money is largely allocated towards increase in the cash balance within the whole life insurance policy.

The presence of a cash balance in this whole life insurance policy creates a source of financing for the owner of the policy. Furthermore, the owner is given greater control over that financing. There is not an approval process required to obtain the funds. There are no time restrictions on the obtaining of funds, no early payment penalties, no points, or the like.

Sometimes, governments impose limits on the amount of money that can be paid into a life insurance policy without losing this kind of control over the cash balance. The United States version of such limits is often termed a Modified Endowment Contract line or “MEC line” for short. However, other nations may have similar limits. Because of the loss of control over the cash balance should the government-imposed limit be exceeded, a few life insurance policy owners try to increase the cash balance of the life insurance policy without triggering any such control-inhibiting limits.

### BRIEF SUMMARY

At least some embodiments described herein relate to the use of an insurance policy to accumulate a cash balance. The insurance policy is set up, however, such that a cash balance can be accumulated more rapidly than conventional insurance policies. The insurance policy is structured such that a portion of a premium for the insurance policy is directed towards non-term coverage that results in some accumulation of cash balance in the insurance policy, and a portion of the premium for the insurance policy is directed towards term coverage. The insurance policy permits additional cash payments beyond the premium to be paid as a cash value increase to the insurance policy. Although these additional cash payments have a limit, the limit may be greater due to the presence of the term coverage than it would be without the term coverage. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a flowchart of a method for setting up and using an insurance policy that is capable of accumulating a cash value that may be borrowed by the owner of the insurance policy, the insurance policy having a paid up additions rider and a dividend accumulating term rider; and

FIG. 2 schematically and symbolically illustrates an insurance policy that includes a paid up addition rider and a dividend accumulation term rider, amongst potentially other components.

### DETAILED DESCRIPTION

In accordance with embodiments described herein, an insurance policy is used to accumulate a cash balance. The insurance policy is set up, however, such that a cash balance can be accumulated rapidly. The insurance policy is structured such that a portion of a premium for the insurance policy is directed towards non-term coverage that results in some accumulation of cash balance in the insurance policy, and a portion of the premium for the insurance policy is directed towards term coverage. The insurance policy permits additional cash payments beyond the premium to be paid as a cash value increase to the insurance policy. Although these additional cash payments have a limit, the limit may be greater due to the presence of the term coverage than it would be without the term coverage in some jurisdictions.

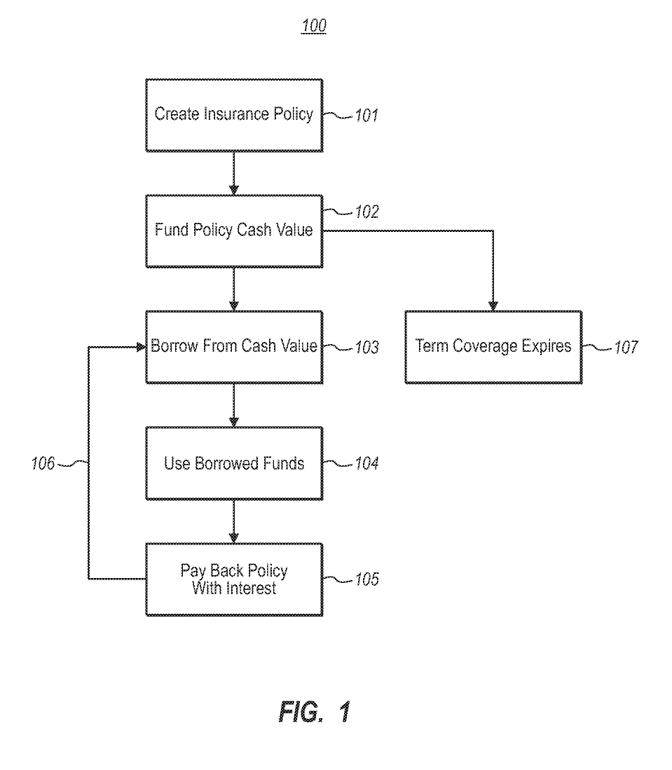

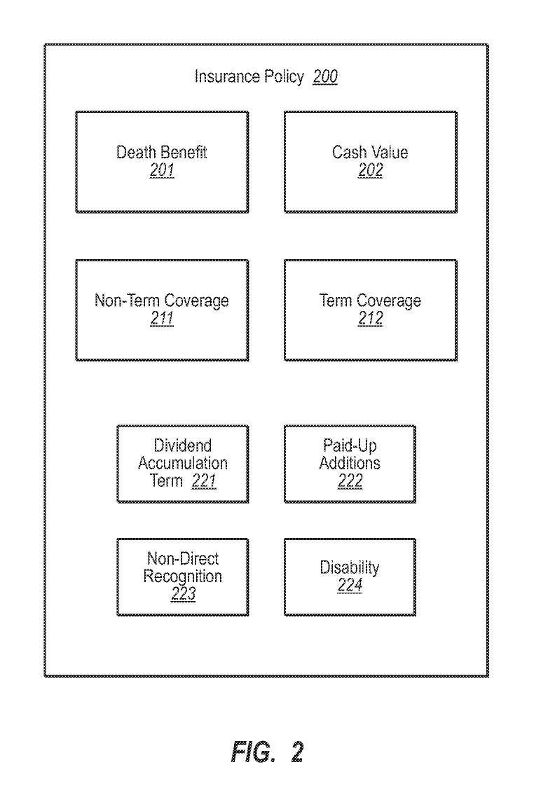

FIG. 1 illustrates a flowchart of a method 100 for setting up and using an insurance policy. FIG. 2 symbolically illustrates an example of the insurance policy 200 that may be set up using the method 100 of FIG. 1. FIG. 1 will now be described, but will frequently refer to the example of FIG. 2 in doing so.

Referring to FIG. 1, an insurance company and an owner of an insurance policy will collaborate to formulate a life insurance policy (act 101). A life insurance policy is essentially a contract between an insurance company and another legal entity called the owner. One of the characteristics of a life insurance policy is that the insurance company will pay a death benefit to some designated beneficiary (either an individual or some other legal entity) upon the death of a person. As is well known, this death benefit can be valuable for the designated beneficiary, as this enables the beneficiary to replace income that was lost when the policy owner died. Referring to FIG. 2, the insurance policy 200 is illustrated as including a death benefit 201. All life insurance policies include a death benefit. That said, however, the principles of the present invention provide substantial benefit outside of the death benefit. The death benefit is merely illustrated here to show that the death benefit is a standard part of all life insurance policies.

There are some life insurance policies that permit a cash balance to be accumulated. Examples of such policies include universal life insurance, variable universal life insurance, and whole life insurance policies. Referring to FIG. 2, the life insurance policy 200 is illustrated as having a cash value 202. The owner of the insurance policy can typically borrow against this cash value, although there is sometimes a contractual limit on the proportion of the cash value that may be borrowed (e.g., 90% or 95%). Typically, the premiums are higher for cash value accumulating insurance policies in order to support the cash value. As time progresses, the cash values of such policies will generally increase, although the performance of cash values in universal and variable universal life insurance is subject to market risk.

Whole life insurance, however, has several useful guarantees. Of course, as with any life insurance policy, there is a guaranteed death benefit. Further, there is a guarantee that the premiums are fixed, which is true for many life insurance policies. Whole life insurance policies are unique, however, in that they guarantee a certain rate of return. This remains true regardless of market conditions. Furthermore, with dividend-paying whole life insurance, there is the strong possibility of dividends, which really represents a refund in excess premiums. Typically, dividends are paid since a safety factor is often built into the insurance policy premiums to account for worst case scenarios. When the circumstances play out, and the worst case did not happen, the insurance company often has excess funds that are refunded to the policy owners as dividends. While dividends may not be one hundred percent guaranteed, some insurance policies have reliably paid dividends on life insurance policies for over one hundred and fifty years, even through the worst of economic times including the Great Depression.

The principles of the present invention apply regardless of whether the cash value accumulating insurance policy is a whole life insurance policy, a variable universal life insurance policy, a universal life insurance policy, or other. However, due to the safety in rate of return of a whole life insurance policy, the principles described herein will often refer to whole life insurance. However, such references should only be viewed as examples, and not viewed as restricting the broader principles of the present invention.

Referring again to FIG. 2, the insurance policy 200 includes a non-term coverage 211 and term coverage 212. In this description and in the claims “term coverage” is defined as a promise from an insurance company that a death benefit of a particular amount will be paid upon the death of a person provided that one or more conditions are met, one of those conditions being that the person died within a particular period of time or “term”. Typically, such terms are defined beginning from the effective date of the policy and extend for a fixed period of time (e.g., 7 years or 10 years). Term coverage does not accumulate a cash balance.

In this description and in the claims, “non-term coverage” is defined as a promise from an insurance company that a death benefit will be paid upon the death of a person (or in some cases earlier than that persons death) regardless of when that person should die. Furthermore, the non-term coverage is often able to accumulate a cash value.

In accordance with the principles described herein, the insurance policy 200 is structured such that a portion of a premium for the insurance policy is directed towards non-term coverage that results in some accumulation of cash balance in the insurance policy (e.g., whole life coverage), and a portion of the premium for the insurance policy is directed towards term coverage. One mechanism for creating such an insurance policy is to add a term rider to the whole life insurance policy. An additional benefit might be obtained by adding a dividend accumulation term rider to a whole life insurance policy. FIG. 2 illustrates that the insurance policy 200 includes a dividend accumulation term rider 221.

The term rider and the dividend accumulation term rider both permit for additional term coverage to be added to an insurance policy that includes non-term coverage. Furthermore, in some countries they also permit additional paid up additions to be paid into the cash value of the policy. However, the dividend accumulation term rider permits those additional paid up additions to be used to increase the death benefit of the policy.

The insurance policy permits additional cash payments beyond the base premium amount to be paid into the insurance policy. Such additional cash payments may primarily be used to increase the cash value of the insurance policy. A mechanism for accomplishing this would be to add a paid up addition rider or paid up insurance rider to the whole life insurance policy. Referring to FIG. 2, the insurance policy 200 is illustrated as including a paid up additions rider 222.

Paid up addition riders have been used in insurance policies for some time for purposes of increasing the cash value of an insurance policy quickly, thereby allowing the owner to have a significant amount of cash from which to borrow. The paid up additions may be used to accumulate cash value over a particular capitalization period. In the United States, that capitalization period is (at present) no less than four years and one day, but may be longer. There are limits imposed by some governments, including the United States, as to how much money may be paid into the insurance policy (even in this capitalization period) before the treatment of the insurance policy changes. In the United States, such a limit is often termed the MEC line.

However, the limits are sometimes calculated based on the total death benefit of the insurance policy. By using a dividend accumulation term rider, the total death benefit is increased within little increase in actual premiums. However, since the death benefit is greatly increased, the amount that may be paid in paid up additions is greater while staying within the limit imposed by government. This latter benefit of a dividend accumulation term rider has not been used to increase the amounts that can be paid in paid up additions, but has conventionally been used simply to provide an additional death benefit at an affordable cost.

For instance, referring to FIG. 2, it is possible to make the term coverage 212 greater than even the non-term coverage 211. The term coverage 212 may even be made equal to, twice, triple or even four times or more that of the non-term coverage 211. Take, for example, a case in which the non-term coverage was $1,000,000. Since this coverage is non-term, the base premium may be quite high; perhaps $10,000 or so depending on health risk at the time the insurance policy became effective. Using a dividend accumulation term rider, the term coverage may be four times that amount, for example, $4,000,000, with a much lower premium (e.g., $4000). The total coverage of the policy would then be $5,000,000, rather than $1,000,000, which only a marginal increase in premiums ($14,000 compared with $10,000). In some countries, the paid up addition limit might then be calculated based on the $5,000,000 amount, allowing the cash value to be funded much more quickly. IRS CIRCULAR 230 DISCLOSURE: To ensure compliance with requirements of the Internal Revenue Service of the United States, you are hereby informed that, to the extent any advice relating to a Federal tax issue is contained in this patent application, it was not written or intended to be used, and cannot be used, for the purpose of (a) avoiding any tax related penalties that may be imposed on you or any other person under the Internal Revenue Code, or (b) promoting, marketing or recommending to another person any transaction or matter addressed in this communication.

Referring to FIG. 1, once the insurance policy has been set up, the owner may then pay additional money into the insurance policy to thereby quickly fund the insurance policy cash value (act 102). Once again, higher paid up additions have been enabled by the higher death benefit of the insurance policy, even though the premiums are still relatively low.

Due to the paid up addition rider, the death benefit of the non-term coverage will increase. In order to keep the death benefit constant, the term coverage may be decrease over time. Therefore, the term coverage may be lower, perhaps much lower, at the time that the term coverage expires as compared to when the term coverage was initiated.

Once the cash value has accumulated sufficiently, the owner may then borrow from the cash balance in the insurance policy (act 103). This borrowing may occur multiple times. Furthermore, the borrowing need not wait for repayment of a prior borrowing. The owner may then use the borrowed funds (act 104). For example, the owner might pay of credit card debt, pay off cars or other depreciable items, pay off a mortgage, purchase real estate, purchase other investments, purchase business capital equipment, loan the funds to others, and so forth. The owner at some point pays back the funds with interest (act 105). This process may be repeated a number of times as represented by arrow 106. However, the process for one iteration need not be completed prior to the initiation of another iteration through borrowing.

At some point, the term coverage expires (act 107), but by this time, the insurance policy may be significantly funded, and the death benefit of the non-term coverage becomes significant, perhaps several factors greater than the original death benefit, due to the paid up addition rider.

In one embodiment, the interest paid back is sufficient to meet the interest requirements of the insurance company. In another more preferred embodiment, the interest exceeds the minimum required interest. Rather, the owner considers the interest rate to be higher than that required by the insurance company. The owner would then simply pay the excess interest not to the insurance company, but back into the insurance policy as paid up additions. In one embodiment, and although not required, when repaying a loan, the repayment may be first allocated to the excess interest by being paid as paid up additions. Once the paid up additions portion representing the excess interest has been paid, then the loan is paid back to the insurance company with the interest that was required by the insurance company. As an example, suppose a loan was to be repayed over a ten year period, the first year or so of the repayment may be paid directly as paid up additions. The remaining nine years or so may be used to repay the loan at the lower interest rate specified by the insurance company.

Referring to FIG. 2, the insurance policy 200 may have the benefit of non-direct recognition 223, although such benefit is not required in order to obtain the fuller benefit of the broader principles described herein. This benefit causes the insurance company to continue to pay the rate guarantees and dividends on the full cash value amount, despite some of that cash value amount having been borrowed. This further reduces the cost of borrowing from the cash balance of the life insurance policy.

The insurance policy 200 may also have a disability rider 224 that at least in some circumstances causes an insurance policy to pay paid up additions on behalf of the owner of the insurance policy when the owner experiences a disability. In addition, the disability rider would cause the insurance company to pay the insurance premium itself in case of disability.

Accordingly, a mechanism for setting up and quickly funding an insurance policy is described. Thus, the cash value may be accumulated quickly, allowing the owner to fill their borrowing needs by resorting to the insurance policy, rather than alternative sources for cash, such as a bank, retirement fund, or other.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for setting up an insurance policy comprising:
an act of causing to be formulated an insurance policy, wherein the insurance policy is structured such that a portion of a premium for the insurance policy is directed towards non-term coverage that results in some accumulation of cash balance in the insurance policy, and a portion of the premium for the insurance policy is directed towards term coverage, wherein the insurance policy permits additional cash payments beyond the premium to be paid as a cash value increase to the insurance policy, wherein the additional cash payments have a limit, the limit being greater due to the presence of the term coverage than it would be without the term coverage; and
an act of paying at least a portion of the additional cash payment into the insurance policy, thereby realizing at least a portion of the cash value increase, wherein the act of paying exceeds the limit as it would exist if the insurance policy did not have the term coverage, but does not exceed the limit as it exists with the term coverage.

2. A method in accordance with claim 1, further comprising:
an act of borrowing from the cash balance in the insurance policy.

3. A method in accordance with claim 2, further comprising an act of using the borrowed funds to do one or more of the following:
an act of paying off credit card debt;
an act of paying off car debt;
an act of paying off a mortgage;
an act of making a real estate investment; and
an act of loaning money to others.

4. A method in accordance with claim 2, further comprising:
an act of paying back with interest the cash borrowed in the act of borrowing, the interest being in excess of the interest owed to an insurance company that issued the insurance policy.

5. A method in accordance with claim 4, wherein the excess interest is at least partially allocated to additional paid up additions that are applied to the insurance policy.

6. A method in accordance with claim 5, wherein in the act of paying back with interest, the excess interest is allocated first out of the repayment, followed by the repayment of the loan and the interest owed to the insurance company.

7. A method in accordance with claim 1, wherein the insurance policy includes a paid up addition or a paid up insurance rider and a dividend accumulation term rider.

8. A method in accordance with claim 1, wherein the insurance policy includes a paid up addition or a paid up insurance rider and a term rider.

9. A method in accordance with claim 1, wherein the insurance policy is a whole life insurance policy.

10. A method in accordance with claim 9, wherein the insurance policy is a dividend paying whole life insurance policy.

11. A method in accordance with claim 10, wherein the insurance policy has a non-direct recognition benefit.

12. A method in accordance with claim 1, wherein the level of term coverage is at least that of the level of non-term coverage in terms of death benefit.

13. A method in accordance with claim 1, wherein the level of term coverage is at least twice the level of non-term coverage in terms of death benefit.

14. A method in accordance with claim 1, wherein the level of term coverage is at least three times the level of non-term coverage in terms of death benefit.

15. A method in accordance with claim 1, wherein the level of term coverage is at least four times the level of non-term coverage in terms of death benefit.

16. A method in accordance with claim 1, further comprising:
an act of letting the term coverage lapse, while the non-term coverage continues.

17. A method in accordance with claim 1, wherein the level of the term is less when the term coverage expires that it was when the term coverage was initiated.

18. A method in accordance with claim 1, wherein the insurance policy further includes a disability rider that at least in some circumstances causes an insurance policy to pay paid up additions on behalf of the owner of the insurance policy in addition to premiums of the insurance policy when the owner experiences a disability.

19. A method for setting up an insurance policy comprising:
an act of causing to be formulated an insurance policy, wherein the insurance policy is structured such that a portion of a premium for the insurance policy is directed towards non-term coverage that results in some accumulation of cash balance in the insurance policy, and a portion of the premium for the insurance policy is directed towards term coverage, wherein the insurance policy permits additional cash payments beyond the premium to be paid as a cash value increase to the insurance policy, wherein the additional cash payments have a limit, the limit being greater due to the presence of the term coverage than it would be without the term coverage.

20. A method in accordance with claim 19, further comprising:
an act of loaning from the cash balance in the insurance policy to the owner of the insurance policy.

21. A method in accordance with claim 19, wherein the insurance policy includes a paid up addition or a paid up insurance rider and a dividend accumulation term rider.

22. A method in accordance with claim 19, wherein the insurance policy has a non-direct recognition benefit.

23. A method in accordance with claim 19, wherein the insurance policy further includes a disability rider that at least in some circumstances causes an insurance policy to pay paid up additions on behalf of the owner of the insurance policy in addition to premiums of the insurance policy when the owner experiences a disability.
